(19) United States
(12) Patent Application Publication
(10) Pub. No.: US 2010/0061738 A1
(43) Pub. Date: Mar. 11, 2010

(54) Signal Processor for Compensating for Optical Fiber Chromatic Dispersion

(75) Inventors: Luca Giorgi, Perignano (Pisa) (IT); Ernesto Ciaramella, Roma (IT); Fabio Cavaliere, Vecchaino (IT); Enrico Forestieri, Parma (IT); Wladek Forysiak, Genova (GB)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/520,787

(22) PCT Filed: Dec. 23, 2006
(86) PCT No.: PCT/IB2006/004207

§ 371 Date: Jul. 17, 2009

(51) Int. Cl. H04B 10/18; H04B 10/04; H04L 27/12

(52) U.S. Cl. 398/149; 398/188; 375/302

(57) ABSTRACT

A signal processor for compensating for optical fibre chromatic dispersion comprising encoding means (5) for encoding a source signal (2) received from a data source (6), splitting means (8) to separate the encoded signal (7) from the encoding means (5) into an in-phase component (10) and an in-quadrature component (11), a first filter means (12) adapted to receive the in-phase component (10) and a second filter means (13) adapted to receive the in-quadrature component (11), the first filter means (12) and second filter means (13) being adapted to filter the in-phase and in-quadrature components respectively. The outputs (14, 15) from the filter means form the input to the optical modulator means (3).

### FIELD OF THE INVENTION

The present invention relates to a signal processor for an optical transmitter, and in particular to a signal processor for compensating for optical fibre chromatic dispersion. It also relates to an optical transmitter including said signal processor.

### BACKGROUND OF THE INVENTION

In optical fibre communication, the quality of a signal deteriorates as it passes from the transmitter to the receiver. Signal degradation is predominately caused by chromatic dispersion. Chromatic dispersion is the separation of a signal into spectral components of differing wavelength. Dispersion may be caused by the material of the optical fibre being such that signals of different frequencies travel at different speeds. This affects the maximum speed at which data can be reliably transmitted. Thus, the highest bit rate at which data can be transmitted is predominately limited by chromatic dispersion. Similarly, since chromatic dispersion occurs as a signal travels along the optical fibre, it will limit the maximum distance that a data signal can travel and be reliably received by a receiver.

Known methods of compensating for chromatic dispersion include use of a Dispersion Compensating Fibre (DCF), alternative modulation formats, or techniques such as Electronic Dispersion Compensation (EDC) employed at the receiver. The use of DCF reduces the pulse distortion caused by dispersion, but DCF is substantially more costly than standard optical fibre. EDC techniques include maximum likelihood sequence estimators or distributed feedback equalizers. Further, modulation formats such as duobinary have been proposed as cost effective alternatives to EDF. While these techniques are effective for high bit rate signals (e.g. 10 Gbit/s or more) over optical fibre lengths of up to 300 km, there is a need for reliable transmission of high bit rate signals over greater distances.

### SUMMARY OF THE INVENTION

According to a first aspect of the invention there is provided a signal processor comprising encoding means for encoding a source signal received from a data source, splitting means to separate the encoded signal from the encoding means into an in-phase component and an in-quadrature component, a first filter means adapted to receive the in-phase component and a second filter means adapted to receive the in-quadrature component, the first filter means and second filter means being adapted to filter the in-phase and in-quadrature components respectively.

This is advantageous as the first filter means and second filter means are such that they filter the in-phase and in-quadrature components of the signal separately so that the chromatic dispersion caused by the optical fibre is compensated for prior to the signal being transmitted along the fibre. As the in-phase and in-quadrature components will be dispersed differently, by filtering them separately the signal can be accurately received as the dispersion is accurately compensated for. Accordingly, it is not necessary to use DCF or EDC at the receiver.

Preferably the first filter means and the second filter means each comprise adjustable microwave integrated circuits. Preferably the first filter means and the second filter means each comprise a Finite Impulse Response (FIR) filter. Preferably, each FIR filter has a tapped delay line architecture having adjustable tap values. The use of FIR filters with adjustable tap values is advantageous as a single transmitter having the signal processor of the invention can be used to compensate for a wide range of chromatic dispersions experienced over a wide range of link distances simply by appropriately changing its tap values.

Preferably the first filter means and second filter means are such that they filter the in-phase and in-quadrature components in accordance with an ideal impulse response, which compensates for the chromatic dispersion. Preferably the filter response is calculated according to the total chromatic dispersion accumulated in a link along which the signal is to be transmitted and shapes the transmitted signal so that a standard Non-Return-to Zero (NRZ) signal is obtained at the receiver.

The first FIR filter means and the second FIR filter means may comprise at least 10 taps. Preferably the first FIR filter means and the second FIR filter means comprise at least 13 taps. However, it will be appreciated that 6, 7, 8, 9, 11, 12, 14, 15, 16 or more taps may be provided. Ideally, the filters comprise between 13 and 15 taps. It will be appreciated that the first FIR filter means may have a different number of taps than the second FIR filter means.

The number of taps, which, in a digital implementation of the signal processor, is related to the memory required to store the tap values, is quite low even for high values of chromatic dispersion. For example, it has been found that 13 taps are sufficient to compensate for 8500 ps/nm of chromatic dispersion, corresponding to 500 km of standard single mode fibre.

Preferably the tap values are determined by software. The tap values may be selected based on the measured dispersion. Preferably, the tap values are calculated in accordance with the ideal impulse responses for compensating chromatic dispersion determined from the intended signal transmission rate, the length of the optical fibre the signal is to be sent through and the predetermined dispersion of the fibre. Preferably the tap values are received by the first filter means and the second filter means via digital to analogue converters. This arrangement is advantageous as it is suitable for the filters to be controlled digitally as the FIR filter can be implemented using a microprocessor of a control means followed by the digital to analogue converter.

Preferably, the in-phase and in quadrature components output by the first filter means and the second filter means are received by an optical modulator means. Preferably, the optical modulator means comprises an in-phase/in-quadrature optical modulator having a first mach zehnder modulator for receiving the in-phase component from the first filter means and a second mach zehnder modulator for receiving the in-quadrature component from the second filter means.

The encoding means may comprise a differential encoder and preferably comprises a duobinary encoder.

According to a second aspect of the invention, we provide an optical transmitter comprising a signal processor according to the first aspect of the invention and an in-phase/in-quadrature optical modulator for receiving the in-phase component and in-quadrature component from the first filter means and the second filter means respectively.

### BRIEF DESCRIPTION OF THE DRAWINGS

The present invention will be understood and appreciated more fully from the following detailed description taken in conjunction with the drawings in which:

FIG. 1 is a diagram illustrating the signal processor in one embodiment of the present invention;

FIG. 2 shows the encoding means of FIG. 1 in more detail;

FIG. 3 is a diagram illustrating the optical modulator means to which the signal processor of FIG. 1 is adapted to be coupled;

FIG. 4 shows the ideal impulse responses to compensate for chromatic dispersion;

FIG. 5 shows a first embodiment of the first filter means and second filter means; and

FIG. 6 shows a second embodiment of the first filter means and second filter means.

### DESCRIPTION OF AN EMBODIMENT OF THE INVENTION

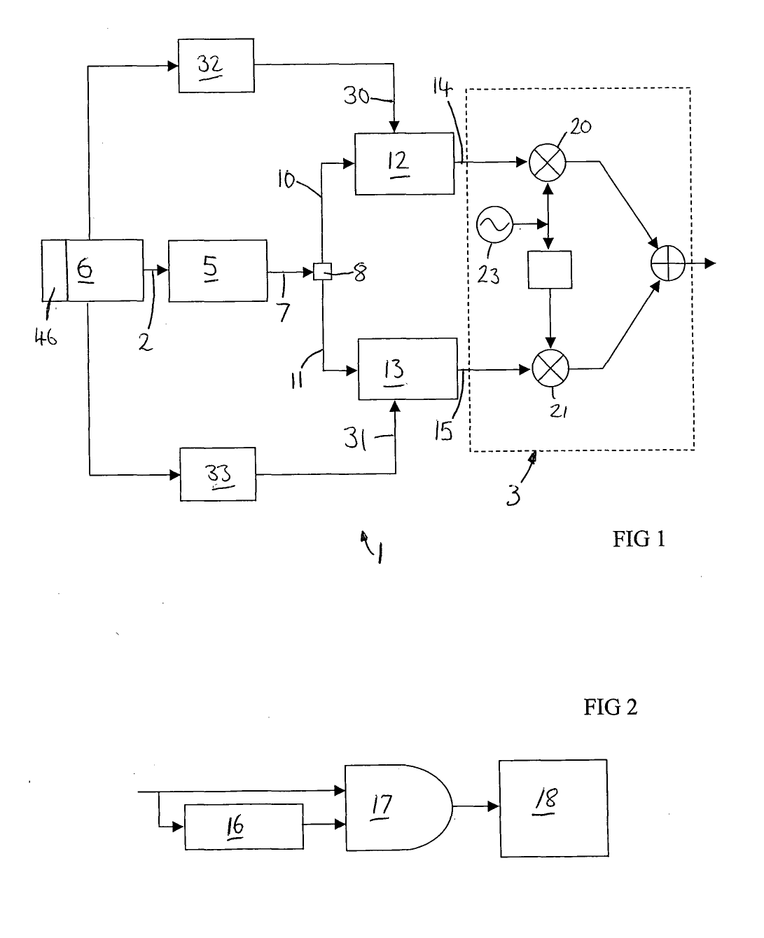

The embodiment of the invention shown in FIG. 1 is a signal processor 1 adapted to receive a source signal 2 and is coupled to an optical modulator means 3. The optical modulator means 3 is coupled to an uncompensated optical fibre 4 for onward transmission of optical signals representative of the source signal 2.

The signal processor 1 comprises encoding means 5 adapted to receive the source signal 2 from a data source 6. The encoding means 5 outputs an encoded signal 7, which is split by a splitting means 8 into an in-phase component 10 and an in-quadrature component 11. The in-phase component 10 is received by a first filter means 12. The in-quadrature component 11 is received by a second filter means 13. The in-phase component 10 is filtered by the first filter means 12 and is output at 14. The in-quadrature component 11 is filtered by the second filter means 13 and is output at 15. The outputs 14 and 15 form the input to the optical modulator means 3.

The splitting means 8 comprises a beam splitter such as a half silvered mirror or two triangular prisms that are commonly used in the art that split a signal into two identical signals.

The encoding means 5 comprises a duobinary encoder. The encoding means 5 encodes the source signal 2 in accordance with the duobinary coding scheme and thus outputs an encoded signal 7. The encoding means 5 is shown in FIG. 2 and comprises a clock and data recovery component 16, an AND gate 17 and a toggle-type flip-flop 18. The operation of the encoding means will be well known to those skilled in the art and therefore will not be discussed in further detail.

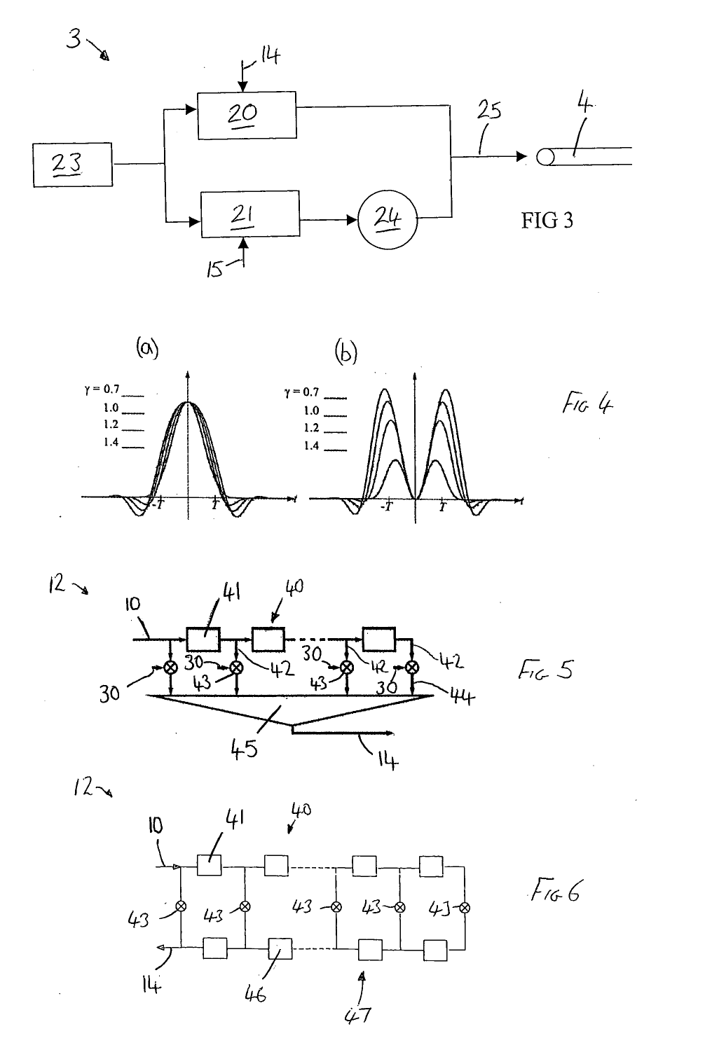

The optical modulator means 3 is shown in FIG. 3 and comprises a first mach zehnder modulator 20 to receive the output 14 and a second mach zehnder modulator 21 to receive the output 15. Alternatively, as will be appreciated by those skilled in the art, the outputs 14 and 15 could drive the two inputs of a dual-drive Mach-Zehnder modulator. The optical modulator means also includes a transmission light source 23 in the form of a laser diode. The modulators 20, 21 modulate the light from the transmission light source using the inputs 14 and 15. The output from modulator 21 is passed through a phase shifter 24 comprising an optical medium with variable refractive index which changes the phase of the component by π/2 radians. The modulator means 3 then combines the modulated light from the first and second modulators 20, 21 into a single beam 25 by way of an optical coupler. The light beam is then transmitted along the optical fibre 4.

The first and second filter means 12 and 13 comprise microwave integrated circuits that form Finite Impulse Response (FIR) filters. The first and second filter means 12 and 13 have thirteen taps each. The first filter means 12 receives a first taps setting signal at tap input 30. The second filter means 13 receives second taps setting signal at tap input 31. The tap values of the thirteen taps of the first filter means are adjusted by the first taps setting signal. Similarly, the tap values of thirteen taps of the second filter means are adjusted by the second taps setting signal. The first and second taps value setting signals are generated by the data source 6 and, via separate digital to analogue converters 32 and 33, are received at the tap inputs 30 and 31. Alternatively, the taps may be set by a computer or bespoke processing device.

FIG. 4 shows the ideal impulse responses for compensating for chromatic dispersion. FIG. 4(a) shows the ideal impulse response for an in-phase component of a signal and FIG. 4(b) shows the ideal impulse response for an in-quadrature component of a signal. The four curves on each of the graphs represent how the ideal impulse response varies with differing amounts of cumulated dispersion, i.e. the fibre dispersion multiplied by the length of the optical fibre. The cumulated dispersion is represented by γ, which is a dimensionless index proportional to the cumulated chromatic dispersion (β₂L) and is defined in equation 1.

$$γ = \frac{{β}_{2} L {λ}^{2}}{π {T}^{2} c} \qquad ( 1 )$$

β₂ is the fibre chromatic dispersion at wavelength λ. L is the length of the optical fibre. T is the bit time and c is the speed of light.

The equation of the curves shown in FIG. 4(a) is given generally as equation 2 and the equation of the curves of FIG. 4(b) is given generally as equation 3.

hᵢ(t)=g(t)cos(at²) (2)

h_{q}(t)=g(t)sin(at²) (3)

in which g(t) is given in equation 4.

$$g ( t ) = \frac{1}{4} [ erfc ( π \sqrt{\frac{2}{ln 2} \frac{t - D / 2}{D}} ) - erfc ( π \sqrt{\frac{2}{ln 2} \frac{t + D / 2}{D}} ) ] + \frac{1}{2} [ erfc ( π \sqrt{\frac{2}{ln 2} \frac{t - D / 4}{D}} ) - erfc ( π \sqrt{\frac{2}{ln 2} \frac{t + D / 4}{D}} ) ] \qquad ( 4 )$$

In equation 4, for a target link length of 500 km, a=0.5·T_{b}², where T_{b} is the bit time, and D is equal to seven times the bit time. Wherein the bit time, T_{b}, is equal to 100 ps at a bit rate of 10 Gbit/s.

The ideal impulse response to compensate for the chromatic dispersion is applied to the in-phase component 10 and in-quadrature component 11 by the first and second filter means 12 and 13 respectively. Thus, by modifying the tap values of the filters 12, 13, pulses that make up the data signal are shaped to approximate the ideal impulse response, as represented in FIG. 4. This enables the signal to be reliably interpreted by a receiver after dispersion has been incurred as the signal is shaped to compensate for the dispersion.

FIG. 5 shows an embodiment of the first filter means 12. It will be appreciated that the structure of the second filter means 13 will be identical, but the tap values will differ in order to apply the ideal impulse response to the in-phase component and the in-quadrature component. The filter means 12 and 13 comprise finite impulse response filters. In general, an FIR filter 12, 13 with N taps extracts N copies of the input signal, each copy is multiplied by a different constant (tap value) and wherein the i-th copy is delayed with respect to the i-th−1 copy by a fixed delay time. Each delay line 41 delays the signal by a time equal to half the bit time. With reference to FIG. 5, the input signal 10 is sent to a plurality of delay lines 41 forming a chain 40. At an output 42 of each delay line 41, part of the signal 10 is dropped and multiplied by the tap value corresponding to that particular part of the signal 10. This is achieved by an amplifier 43 or an attenuator 44, depending on the tap value the particular part of the signal 10 is to be multiplied by to achieve the ideal impulse response. Finally, all these dropped signals are summed up at 45 to give the output 14 of the filter 12. The amplifier 43 comprises a variable gain amplifier and the attenuator 44 is a variable attenuator, each being controlled by means of an electrical pin (not shown) that receives the tap values 30. Although only one tap value input 30 is shown in FIG. 1, each pin is connected to the data source 6 via a control means 46, which supplies each amplifier 43 or attenuator 44 with a tap value, which is used to control the amount of amplification or attenuation.

FIG. 6 shows a second embodiment of the FIR filter 12 in which the summing function performed at 45 is instead performed by a plurality of delay lines 46 forming a chain 47. The chain 47 comprises the same number of delay lines 46 as chain 40. Given that the delay applied to the signal by each delay line 41 is τ_{D} and the delay applied to the signal by each delay line 46 is τ_{G}, then τ_{G} and τ_{D} are such that |τ_{G}+τ_{D}|=T/2 where T is the bit time. The filter of FIG. 6 allows for a more spatially compact realisation.

The tap values 30 are chosen by consideration of the equations 2 and 3. In particular, equations 5 and 6 are used to determine each tap value. The filters 12, 13 of FIGS. 5 and 6 have thirteen taps. The tap value for each tap are denoted by cₖ for the filter 12 based on hᵢ(t) and by dₖ for the filter 13 based on h_{q}(t). Assuming that the pulse at the input of both FIR filters is a δ(t)-Dirac function, each tap value is defined by equations 5 and 6.

$$\begin{matrix}{c}_{k} = {h}_{i} ( \frac{k - N / 2}{2} T ) \\ k = 0 , 1 , … , N & ( 5 ) \\ {d}_{k} = {h}_{q} ( \frac{k - N / 2}{2} T ) \\ k = 0 , 1 , … , N & ( 6 )\end{matrix}$$

The shape of the ideal filters depends on the cumulated dispersion that we want to compensate (see FIG. 2). Therefore when the cumulated dispersion changes, for example when the transmitter is used over a different length of optical fibre, the tap values or the number of taps may need to be changed so that the FIR filters effectively modify the signal to compensate for the dispersion. To select the number of taps used at the filters 12, 13 the bit error rate (BER) at the receiver is measured. The number of taps can then be selected to reduce the BER. Increasing the number of taps causes the BER to decrease, at least up to a number of 13-15 taps.

The FIR filters 12, 13 are fed with an electrical data sequence, coming from the original NRZ data sequence received from the data source 6 and processed by the duobinary encoder 5. Each pulse that makes up the signal should have a duration not exceeding T/2 and, ideally, is a rectangular pulse of length T/2.

The dispersion of an optical fibre link can be measured by means, of one of the standard methods known to those skilled in the art detailed in ITU-T recommendation G.650, for example. The filter shape is given by equations 2, 3 and 4. Then, once the filter response has been calculated, various standard techniques can be used to calculate the tap values. Such methods are well known and are described in many signal processing textbooks for graduates, such as M. J. Jeruchin et al. “Simulation of Communication Systems” Second Edition, Kluwe Academic, page 149 onwards.

If only an approximated value of the dispersion is known, the approximated value may be sufficient to ensure a satisfactory performance in terms of received BER (Bit Error Rate) based on the tap values derived therefrom. This is expected to be the most common situation because it is common for receivers to have some tolerance to the dispersion (for example about 800 ps/nm, corresponding to 50 Km of standard single mode fibre) and use Forward Error Correction (FEC) techniques. If the dispersion is completely unknown or its approximated value is insufficient, the tap values can be adjusted by means of usual mathematical methods (e.g. the gradient method). Alternatively, a dispersion measurement may be required. The dispersion of an optical fibre link 4 can be done once, typically at the time of system installation, and thus does not need to be repeated when each channel is fitted into the system.

There are two methods that can be used to calculate the tap values so that the output of each filter 12, 13 is the appropriately modified signal to compensate for the dispersion of the optical fibre 4. With reference to equations 5 and 6, the first method takes into consideration the temporal superposition produced by filtering the NRZ pulse with duration greater than T (bit time) with a FIR filter with N+1 taps spaced by T/2. The second option is based on knowing the Fourier transform of a NRZ pulse at the input of each FIR filter 12, 13 and the Fourier transform of each output. The new frequency response of FIR filters is equal to the ratio between the output and the input signal of each FIR filter in the frequency domain. Thus, based on the link chromatic dispersion, the tap values that implement the transfer functions of equations 2 and 3 are calculated. There are standard methods to do this that will be known to those skilled in the art and which can be implemented by a software routine having as its input the dispersion values and as its output an array containing the tap values. The tap values are transferred from the signal source 6 or other programmable device (not shown) to the FIR filters 12, 13 via the control means 46. Once the tap values have been set the signal source 6 or other programmable device (not shown) can be disconnected.

Furthermore, the tap values can be modified to compensate for the non-linear electro-optical characteristic of the I/Q modulator 3, which could produce different in-phase and in-quadrature components of the optical E-field.

1-17. (canceled)

18. A signal processor comprising:
an encoder to encode a source signal received from a data source;
a splitter to separate the encoded signal from the encoder into an in-phase component and an in-quadrature component;
a first filter to receive the in-phase component;
a second filter to receive the in-quadrature component; and
the first filter and the second filter configured to filter the in-phase and in-quadrature components, respectively.

19. The signal processor of claim 18 wherein each of the first and second filters comprise adjustable microwave integrated circuits.

20. The signal processor of claim 18 wherein each of the first and second filters comprise a Finite Impulse Response (FIR) filter.

21. The signal processor of claim 20 wherein each FIR filter has a tapped delay line architecture to receive adjustable tap values to control the operation of the FIR filter.

22. The signal processor of claim 18 wherein the first and second filters are configured to filter the in-phase and in-quadrature components, respectively, according to an ideal impulse response.

23. The signal processor of claim 22 wherein the filter response is calculated according to a total chromatic dispersion accumulated in a link along which a signal is to be transmitted, and shapes the transmitted signal so that a standard Non-Return-to Zero (NRZ) signal is obtained at a receiver.

24. The signal processor of claim 20 wherein the first FIR filter and the second FIR filter comprise at least 10 taps configured to receive tap values.

25. The signal processor of claim 24 wherein each of the first FIR filter and the second FIR filter comprise at least 13 taps to receive tap values.

26. The signal processor of claim 25 each of the first FIR filter and the second FIR filter comprise between 13 and 15 taps to receive tap values.

27. The signal processor of claim 21 wherein the tap values are determined by software.

28. The signal processor of claim 22 wherein the tap values are calculated based on the ideal impulse responses for compensating chromatic dispersion determined from an intended signal transmission rate, the length of the optical fiber the signal is to be sent through, and a predetermined dispersion of the fiber.

29. The signal processor of claim 21 wherein the tap values are received by the first and second filters via respective digital to analog converters.

30. The signal processor of claim 18 wherein the in-phase and in-quadrature components output by the first and second filters are received by an optical modulator.

31. The signal processor of claim 30 wherein the optical modulator comprises an in-phase/in-quadrature optical modulator configured to receive the in-phase component from the first filter, and the in-quadrature component from the second filter.

32. The signal processor of claim 18 wherein the encoder comprises a differential encoder.

33. The signal processor of claim 18 wherein the encoder comprises a duobinary encoder.

34. An optical transmitter comprising:
a signal processor comprising:
an encoder to encode a source signal received from a data source;
a splitter to separate the encoded signal from the encoder into an in-phase component and an in-quadrature component;
a first filter to receive the in-phase component;
a second filter to receive the in-quadrature component; and
the first filter and the second filter configured to filter the in-phase and in-quadrature components, respectively; and
an in-phase/in-quadrature optical modulator configured to receive the in-phase component and the in-quadrature component from the first and second filters, respectively.
